(19) United States
(12) Patent Application Publication
(10) Pub. No.: US 2014/0170266 A1
(43) Pub. Date: Jun. 19, 2014

(54) COMPOSITION WITH IMPROVED DIGESTIBILITY OF PROTEINS

(71) Applicants: Andries Dirk Siemensma, Leeuwarden (NL); Gijsbert Klarenbeek, Ommen (NL); Christina Josephina Antonia Maria Timmer-Keetels, Witteveen (NL); Ynte Piet de Vries, Deventer (NL); Albert van der Padt, Apeldoorn (NL); Albert Thijs Poortinga, Apeldoorn (NL)

(72) Inventors: Andries Dirk Siemensma, Leeuwarden (NL); Gijsbert Klarenbeek, Ommen (NL); Christina Josephina Antonia Maria Timmer-Keetels, Witteveen (NL); Ynte Piet de Vries, Deventer (NL); Albert van der Padt, Apeldoorn (NL); Albert Thijs Poortinga, Apeldoorn (NL)

(73) Assignee: FRIESLAND BRANDS B.V., Amersfoort (NL)

(21) Appl. No.: 14/131,724

(22) PCT Filed: Jul. 13, 2012
(86) PCT No.: PCT/NL2012/050508

§ 371 Date: Mar. 6, 2014

(30) Foreign Application Priority Data
Jul. 13, 2011 (NL) 2007096

(51) Int. Cl. A23C 9/16

(52) U.S. Cl. CPC A23C 9/16
USPC 426/61; 426/491; 426/330.2; 426/588; 426/71; 426/384; 426/471; 426/311

(57) ABSTRACT

The present invention relates to method to produce a dairy based food composition comprising protein comprising the steps (a) Treating the milk such that at least 98% of the pathogens is removed, (b) Treating the milk with a microfilter of a poresize of 0.01-2 micron such that at least a casein rich fraction and a serum protein rich fraction is obtained, wherein the milk is subjected to a heating treatment before or after the microfiltration and wherein during the production the milk and products obtained from the milk are not subjected to a heat treatment at a temperature above 90° C., and wherein the serum protein rich fraction and/or the casein rich fraction is processed into a food product. The invention also is directed to products made by the process.

### BACKGROUND

Raw milk and products thereof are perceived by consumers as natural and good. The taste of raw milk (products) is judged as better, more tasteful and natural. However there is drawback to using raw, unpasteurized milk and that is the health safety as pathogenic bacteria are not killed. Healthy persons probably run a low risk when consuming raw milk products, however infants, elderly people and pregnant women are advised not to consume raw milk products for health reasons. Normally to mitigate the risk of raw milk, the milk is pasteurized. This yields a safe, cold-shelf stable food.

The pasteurization or sterilization of milk provides safe products in microbial terms, however the heat treatment denatures proteins, such as antibodies and other bioactive proteins that would have been beneficial in native state. Heat treatment of milk also stimulates glycation of proteins. Infant and follow-on formulas are more prone to thermally induced degradation reactions than regular milk products as a consequence of their special composition. Degradation reactions observed during milk processing comprise lactosylation yielding the Amadori product lactulosyllysine, the formation of advanced glycation end products (AGEs), and protein-free sugar degradation products, as well as protein or lipid oxidation (Pischetsrieder and Henkle. Amino acids 2010). It has been shown that glycated proteins are digested poorly if digested at all.

Recently it has been shown that raw milk is digested significantly faster with human proteolytic enzymes than pasteurized treated milk. Furthermore, it has been shown that food processing, and primarily the heat treatment, increases the casein resistance in infants. There is also seen an inverse relationship between consumption of unprocessed cow's milk and the development of childhood asthma and allergies. It seems that pasteurization of milk proteins promotes allergic sensitation (Roth-Walter et al. Allergy 2008; 63:882-890). It is known that the resistance to in vivo digestion of an allergenic food protein increases its potential for causing an allergic reaction in susceptible individuals. Therefore the stability to digestion might be a valid parameter that distinguishes food allergens from non-allergens (Schnell and Herman, Clinical and Molecular Allergy 2009, 7:1).

There are thus opposite requirements for microbial safe food products and low-allergenic food products. However, especially for demographic groups that are vulnerable such as infants and toddlers, old people and sick people, it is important to provide microbial safe food, while at the same time it is desirable to provide food that is easily digested by them with the minimum amount of allergens, including denatured and glycated ingredients.

A background reference on providing protein fraction from milk with microfiltration is U.S. Pat. No. 5,169,666. Herein bovine milk is subjected to low temperature ultrafiltration or microfiltration.

Another background reference is EP2238842 wherein the amount of AGE products is reduced by treating a protein phase and carbohydrate phase separately.

Another background reference is EP 1 133 238. Herein a whey protein composition, is manufactured by subjecting milk that has not been heat-treated, or at most has undergone a moderate heat treatment, to microfiltration at elevated temperature (typically 50° C.).

A further background reference is WO 2008/127104. This concerns a serum protein product suitable as an ingredient for e.g. babyfoods, which is obtained by micro-filtration of bovine milk at a temperature of 10° C.-20° C. utilizing a membrane having a pore size of between 0.3 and 0.5 micron.

### SUMMARY OF THE INVENTION

It is an object of the present invention to provide a dairy based composition wherein the proteins are denatured to a minimal level however at the same time possess the minimal microbial safety. The present invention provides a solution for this dilemma.

The present invention is directed to a method to produce a dairy based food composition comprising protein comprising the following steps
(a) Treating the milk such that at least 98% of the pathogens is removed
(b) Treating the milk with a microfilter of a poresize of 0.01-2 micron such that at least a casein rich fraction and a serum protein rich fraction is obtained,

wherein the milk is subjected to a heating treatment before or after the microfiltration and wherein during the production the milk and products obtained from the milk are not subjected to a heat treatment at a temperature above 90° C., and wherein the serum protein rich fraction and/or the casein rich fraction is processed into a food product.

In addition, the present invention is directed to a food composition obtainable by a method according to the invention.

Furthermore, the present invention is directed to a dairy based composition wherein the composition is a casein rich fraction wherein more than 80 wt % of the protein is casein and less than 25 wt % of the protein is denatured.

Another embodiment of the present invention is directed to a dairy based composition wherein the composition is a serum protein rich fraction wherein more than 20 wt % of the protein is serum protein and less than 25 wt % of the protein is denatured.

Moreover, the present invention is related to a dairy based food composition wherein less than 25 wt % of the protein is denatured and the ratio of casein:serum protein is 0.1-15.

### DETAILED DESCRIPTION

The present invention provides a method to produce a dairy based food composition, which is microbially safe and at the same time the proteins have an improved digestibility.

There are many methods available for a skilled person to measure the digestibility of proteins e.g. methods described by, for instance, Takagi et al, Biol Pharm Bull 2003; 26(7):969-973; Thomas et al, Reg Tox Pharmacol 2004; 39:97-98; Almaal et al, Int Dairy J 2006; 16:961-968; Sanz et al, J Agric Food Chem 2007; 55:7916-7925; Herman et al, Reg Toxicol Pharmacol 2005; 41:175-184; Heman et al, Reg Toxicol Pharmacol 2008; 52:94-04; Dupont et al, Mol Nutr Food Res 1010; 54:767-780; Dupont et al, Mol Nutr Food Res 1010; 54:1677-1689.

It was surprisingly found that a microbiologically safe dairy product may be obtained while at the same time avoiding excessive denaturation of proteins, when milk is treated such that at least 98% of the pathogens is removed and the milk is microfiltered through a poresize of 0.01-2 micron such that at least a casein rich fraction and a serum protein rich fraction is obtained. A heating step after the pathogen removal step inactivates lipases that may have been released in the pathogen removal step and may also kill residual pathogens. In a suitable embodiment of the present invention and/or embodiments thereof, the heat treatment is at a temperature above 50° C., more suitably above 51° C., 52° C., 53° C., 54° C., or 55° C., even more suitably, above 56° C., 57 C.° C., 58° C., 59° C., or 60° C., even more suitably the temperature is above 61° C., 62° C., 63° C., 64° C., or 65° C., or even above 66° C., 67° C., or 68° C. In order to avoid as much denaturation as possible, during the production of the food composition, the milk and products obtained from the milk are during the production not subjected to a heat treatment at a temperature above 90° C., preferably not above 88° C., more preferably not above 87° C. or not above 86° C., more preferably not above 85° C., even more preferably not above 84° C., not above 83° C., not above 82° C., not above 81° C. or not above 80° C., even more preferably not above 79° C., not above 78° C., not above 77° C., not above 76° C. or not above 75° C., yet even more preferably not above 74° C., not above 73° C., not above 72° C., not above 71° C. or not above 70° C., more preferably not above 69° C. or not above 68° C. and most preferably not above 67° C., not above 66° C. or not above 65° C. In a preferred embodiment of the present invention and embodiments thereof, milk and the products obtained from the milk during the process when they are in a liquid state, are not subjected to a heat treatment above 74° C., 75° C., or 76° C., preferably not above 73° C., 72° C., or 71° C., more preferably not above 67° C., 68° C., or 69° C. and most preferably not above 64° C., 65° C., or 66° C. In a preferred embodiment, the temperature of the heating treatment is between, 50° C. and 85° C., more preferably between 53° C. and 81° C., more preferably between 56° C. and 79° C., more preferably between 58° C. and 74° C., even more preferably between 60° C. and 72° C., more preferably between 63° C. and 70° C. and most preferably 65° C. and 68° C.

It is to be understood that milk and the products obtained from the milk during the process of the invention when they are in a dry state may be subjected to a higher temperature than milk and products in a liquid state but not above 90° C., 85° C., or 74° C. according to the invention. According to the present invention, a dry product or a product in a dry state comprises at least 70 wt % dry matter, more preferably at least 73 wt % dry matter, or 75 wt % dry matter, more preferably at least 77 wt % dry matter, or 80 wt % dry matter, more preferably at least 82 wt % dry matter or 85 wt % dry matter, more preferably at least 87 wt % dry matter, or 90 wt % dry matter, and most preferably at least 92 wt % dry matter or 95 wt % dry matter or even more than 98 wt % dry matter.

In a preferred embodiment of the present invention and embodiments thereof, during the production of the food composition, the milk and products obtained from milk when a heat treatment is performed, the heat treatment is performed at a temperature below, 90° C., preferably below 88° C., below 86° C., or below 85° C., more preferably below 84° C., below 83° C., below 82° C. below 81° C., or below 80° C., even more preferably below 79° C., below 78° C., below 77° C., below 76° C., or below 75° C., more preferably below 74° C., below 73° C., below 72° C. below 71° C., or below 70° C., more preferably below 69° C. or below 68° C. and most preferably below 67° C., below 66° C., or below 65° C. In a preferred embodiment of the method of the present invention and embodiments thereof, during the process of the food production milk and the products obtained from the milk when they are in a liquid state, when a heat treatment is performed, the heat treatment is performed at a temperature below 75° C., preferably below 74° C., below 72° C., or below 72° C., more preferably below 71° C., below 70° C., below 69° C., or below 68° C. and most preferably below 67° C., below 66 C.° or below 65° C. It is to be understood that during the process of the invention milk and the products obtained from the milk when they are in a dry state may be subjected to a heat treatment, and when a heat treatment is performed this may be done at a higher temperature than milk and products in a liquid state but below 90° C., more preferably below 88° C., below 86° C., or below 85° C., even more preferably below 84° C., below 83° C., below 82° C. below 81° C., or below 80° C., and most preferably below 79° C., below 78° C., below 77° C. below 76° C., or below 75° C.

According to the present invention, a dry product or a product in a dry state comprises at least 70 wt % dry matter, more preferably at least 73 wt % dry matter, or 75 wt % dry matter, more preferably at least 77 wt % dry matter, or 80 wt % dry matter, more preferably at least 82 wt % dry matter or 85 wt % dry matter, more preferably at least 87 wt % dry matter, or 90 wt % dry matter, and most preferably at least 92 wt % dry matter or 95 wt % dry matter or even more than 98 wt % dry matter.

According to the present invention denaturation of proteins is a process wherein the protein loses wholly or partially its function; it may include unfolding of the protein, partially unfolding of the protein, aggregation of proteins, glycation of protein and any other state of the protein that causes the protein to loose its function.

Unfolding is a process in which proteins lose their tertiary structure and/or secondary structure. Denatured proteins can exhibit a wide range of characteristics, from loss of solubility to communal aggregation.

Glycation is the result of the bonding of a protein with a sugar molecule, such as fructose or glucose, without the controlling action of an enzyme. Glycation is a haphazard process that impairs the functioning of biomolecules. Through the Maillard reaction, certain amino acids such as lysine can react with aldehyde groups of glucose to create first Schiff bases and then rearrange to Amadori products. These reactions produce various glycoxidation and lipoxidation products which are collectively known as glycation products such as AGE (Advanced Glycation Endproducts). For example, glycation products are formed by the Maillard reaction during food processing when mixtures containing protein and carbohydrates are heated. However, glycation products may also be formed endogenously in the body and probably contribute to the natural aging process and age related diseases.

Aggregation of protein is the sticking together of the protein with the same or other proteins or to other ingredients such as fat globules.

The amount of glycation products in nutritional compositions of the present invention can be quantified by measuring the percentage of blocked lysine. As will be appreciated numerous different glycation products and their reactive precursors exist. Various tests for glycation products have been proposed in the literature but it will be appreciated that it is impractical to test for every possible compound that might be present. However, a universal feature of nutritional compositions containing proteins and carbohydrates that have undergone a heat treatment is a reduction in the amount of available lysine in the heat treated composition. Thus, measurement of blocked lysine is an indicator not only of the specific reaction of reducing sugars with free lysine groups but also a marker for the presence of other glycation products and the temporary presence of earlier reactive intermediates. For example, the percentage of blocked lysine in products which are commercially available varies between 3 and 17% depending upon the composition of the product with products containing lactose at the higher end of this scale and lactose free products at the lower end of the scale.

It should be appreciated that the measurement of glycation products and intermediates thereof can also be determined by any currently available analytical techniques or methods known to one skilled in the art. For example, one such alternative method is the quantification of carboxymethyllysine which is described in “Advanced glycoxidation end products in commonly consumed foods” by Goldberg et al, J. Am Diet Assoc 2004, 104(8) 1287-91.

Several indicators for glycation products have been suggested such as furosine and carboxymethyllysine for early Maillaird reactions, isomerisation of lactulose, galactose or tagatose for advances Maillard reactions and brown colouring as final Maillard reaction (van Boekel, Food Chemistry vol 62 No 4, p 403-414, 1998).

Furthermore, HPLC, mass spectrometry and fluorometric or spectrofotometric assay have been used to measure glycation products (Jones et al. Journal of Chromatography A 822 (1998) 147-154; Moreno et al. J Am Soc Mass Spectrom 2008, 19, 927-937; Ferrer et al. Food 47 (2003) No. 6, pp. 403-407; Vigo et al: Food Chemistry 44 (1992) 363-365).

Unfolding of protein and aggregation of protein may be measured by methods described in amongst others: Dairy Science and Technology, Walstra, Wouters, Geurts, Taylor & Francis, CRC Press 2006, Heat-induced changes in milk, ed PF Fox, International Dairy Federation, 1995; Advanced dairy chemistry Vol 1 Proteins, ed. PF Fox and PLH McSweeney Thermal Denaturation and Aggregation of Whey Proteins; M. Donovan and D. M. Mulvihill Irish Journal of Food Science and Technology Vol. 11, No. 1 (1987), pp. 87-100; TEAGASC-Agriculture and Food Development Authority, Stable URL: http://www.jstor.org/stable/25558155;

International Dairy Journal 14 (2004) 399-409 Heat-induced denaturation/aggregation of b-lactoglobulin A and B: kinetics of the first intermediates formed, Thomas Croguenneca, Brendan T. O′Kennedyb, Raj Mehra.

It should be understood that many different methods exist to measure protein denaturation and protein aggregation. Depending on the circumstances one method may be more suitable than another. A skilled person will know when to use these.

An often used method to separate denatured milk proteins from native milk proteins is precipitation at pH 4.6. The denatured whey fractions as well as the casein precipitate while the supernatant contains the native whey protein. The denatured fraction and native fraction may be separated by e.g. centrifugation, filtration etc. The native and/or denatured protein may be analyzed by any method known by a skilled person such as, agarose gel electrophoresis, poly-acrylamide gel electrophoresis (PAGE), native-PAGE, SDS-PAGE, HPLC, CZE, LC-MS, Malvern and many others.

According to the invention and embodiments thereof, for microbial safety the milk is treated such that at least 98% of the pathogens is removed. In a preferred embodiment, the pathogens are removed at a temperature below 68° C., more preferably below 67° C., below 66° C. or below 65° C., more preferably below 64° C., below 63° C. or below 62° C., even more preferably below 61° C. below 60° C., or below 59° C. Suitably, the pathogens are removed at a temperature of about 45 to 58° C., more preferably from about 47° C. to 57° C., even more preferably from 49° C. to 56° C., even more preferably from about 50 to 55° C., and most preferably from 52° C. to 54° C.

Pathogen removal techniques are known such as bacterial filtration with a poresize of 0.5-2.5 micron, centrifugation, or use of antibodies to remove pathogens. It is to be understood that there may be other methods that remove pathogens. Any method is suitable as long as it removes at least 98% of the pathogens and is safe for a food product and does not involve heating to a temperature above 90° C., preferably not above 85° C. or preferably not above 74° C.

The bacterial filtration with a filter with a poresize of 0.5-2.5 micron removes pathogens such as bacteria and spores that are larger than 0.5-2.5 microns. Suitably the poresize of the bacterial filter is between 0.7 and 2 micron and more preferably between 1 and 1.5 micron. A suitable example of such a bacterial filtration is bactocatch. In a preferred embodiment the bacterial filtration to remove pathogens is conducted at a temperature of from 0° C. to 25° C., more preferably of from 2° C. to 22° C. or from 5° C. to 20° C., even more preferably of from 7° C. to 17° C. and most preferably of from 10° C. to 15° C. or from 12° C. to 14° C.

Pathogens may also be removed by centrifugation. The milk is centrifuged at high speed, e.g. from 4000 rpm to 8000 rpm to remove the pathogens. Suitable centrifuge speeds are from 5000 rpm to 7500 rpm, more suitably from 6000 rpm to 7000 rpm. Suitably the pathogens are removed by a bactofuge (eg ex Tetrapak).

Another suitable method of the invention and embodiments thereof to remove pathogens is the use of antibodies. Antibodies may be designed to recognize specific pathogens or a wide range of pathogens. Preferably the antibodies are immobilized to a column or beads so that they can be easily removed. Alternative to removal of the pathogens, mild pathogen killing methods may be used, such as one selected from the group consisting of micro-wave heating, radio frequency heating, ohmic heating, inductive heating, high pressure processing, pulsed electric field, high impedance electroporation, pulsed magnetic field, ultrasound, irradiation, pulsed light, UV light, treatment with a gas such as dense phase CO2, ozone or chlorine dioxide and any combination thereof. It is to be understood that the mild pathogen killing treatment is mild to the proteins such that less than 25 wt % of the proteins is denatured. It is to be understood that the term “denatured” relates only to denaturable proteins, that is only to serum proteins. The mild pathogen killing treatment should at least kill 98% of the pathogens. More than one pathogen removal steps and/or pathogen killing steps may be carried out. Also combinations of the pathogen removal steps and mild pathogen killing step are envisioned.

In a preferred embodiment at least 98.5% of the pathogens are removed or killed, more preferably at least 99% of the pathogens are removed or killed, and more preferably at least 99.5% of the pathogens are removed or killed.

In a preferred embodiment of the method of the invention and embodiments thereof pathogens that are removed or killed are selected from the group consisting of gram negative bacteria, gram positive bacteria, heat resistant bacteria, spores, virus, and parasites. Pathogens that are common to food products and may present a health hazard include amongst others Listeria monocytogenes, Staphylococcus aureus, Salmonella spp., Escherichia coli, Enterococcus spp., Mycobacterium avium, Campylobacter, Yersinia enterocolitica, Pseudomonas spp., Aeromonas spp., Giardia, Cryptosporidium parvum.

The microfiltration of the method of the present invention and embodiments thereof is generally conducted using a microfilter having a pore size in the range of from 0.01 to 2 micron, preferably from 0.05-1.2 micron, more preferably from 0.1-0.8 micron and most preferably from 0.15 to 0.5 micron. Suitable microfilters are known in the art and include, e.g. spiral wounded polymer or ceramic based systems

For the microfiltration, any conventional apparatus for crossflow microfiltration can be used. Thus, for instance, use can be made of a spiral-wound microfiltration membrane, for instance as described in EP-A-1673975. Preferably, a process system with multiple spiral-wound modules is used. It has been found that it is helpful that in the crossflow microfiltration process measures are taken for reducing the transmembrane pressure across the membrane, in such a manner that the transmembrane pressure is 2.5 bar at a maximum. For that reason, preferably, the transmembrane pressure during microfiltration in a method according to the invention is kept relatively low, that is, 2.5 bar at a maximum. Good results as regards the protein composition of the permeate have for instance been obtained at a maximum transmembrane pressure of 2 bars. The average transmembrane pressure may vary, and is for instance 0.1 to 1.8 bar. In a specific embodiment, the maximum transmembrane pressure is from 0.2 to 1.5 bar, more preferably from 0.3 to 1.2 bar, more preferably from 0.5 to 1 bar and most preferably from 0.6 to 0.8 bar.

Instead of reducing the transmembrane pressure, a different solution may be the use of microfiltration membranes having a gradient in the porosity or thickness of the membrane layer.

In a method according to the invention and embodiments thereof, standard microfiltration membranes having a pore size of between 0.01 and 2 μm may be used. As is known in general, pore size influences the eventual protein composition of the permeate and the retentate. In the light of the present invention, the pore size proves to have an influence inter alia on both the serum protein to casein ratio and the proportion of beta casein in the casein fraction. In an embodiment, use is made of a membrane, for instance a spiral-wound membrane, having a pore size of between 0.1 and 0.8 μm, preferably between 0.15 and 0.5 μm.

The microfiltration steps are conducted starting from milk that comprises mostly non-denatured milk protein. This may refer to raw (untreated) milk, or to milk that has undergone a mild heat treatment, but has not been subjected to a temperature higher than 90° C., preferably not higher than 88° C., not higher than 87° C., not higher than 86° C., or not higher than 85° C., more preferably not higher than 84° C., not higher than 83° C., not higher than 82° C., not higher than 81° C., or not higher than 80° C., even more preferably not higher than 79° C., not higher than 78° C., not higher than 77° C., not higher than 76° C., or not higher than 75° C., more preferably not higher than 74° C., not higher than 73° C., not higher than 72° C., not higher than 71° C., or not higher than 70° C., more preferably not higher than 69° C., or not higher than 68° C. and most preferably not higher than 67° C., not higher than 66° C. or not higher than 65° C. The milk may be whole milk or milk which has been skimmed to a greater or lesser degree, raw milk, bactofuged milk or bactofiltered milk or milk wherein otherwise pathogens are removed, or milk pasteurized under mild conditions or reconstituted from powdered milk dried at low temperature. Preferably, non heat-treated, skimmed raw milk is used. If heat-treated, this is done at a temperature below the denaturing temperature of the relevant milk proteins, preferably below 90° C., below 88° C., below 86° C., or below 85° C., more preferably below 84° C., below 83° C., below 82° C. below 81° C., or below 80° C., even more preferably below 79° C., below 78° C., below 77° C. below 76° C., or below 75° C., more preferably below 74° C., below 73° C., below 72° C. below 71° C., or below 70° C., more preferably below 69° C. or below 68° C. and most preferably below 67° C., below 66° C., or below 65° C.

The milk provided to the process of the invention can, in principle, be from any dairy animal. This is mostly cattle, and particularly cow (adult female cattle), but in addition to cattle, the following animals provide milk used by humans for dairy products: Camels, Donkeys, Goats, Horses, Reindeer, Sheep, Water buffalo, Yaks, and Moose. Most preferably, the milk used in the invention is cow's milk.

The microfiltration step may be performed at a temperature between 0 and 65° C. Preferably the microfiltration performed at a temperature of between 25 and 65° C. or between 0 and 25° C. More preferably the microfiltration step is performed at a temperature of from 0° C. to 25° C., more preferably of from 2° C. to 22° C. or from 5° C. to 20° C., even more preferably of from 7° C. to 17° C., more preferably of from 10° C. to 15° C. or from 12° C. to 14° C. and most preferably from 11° C. to 16° C.

The microfiltration separates the milk into a permeate and retentate. The retentate is a casein rich fraction and the permeate is a serum protein rich fraction. In the casein rich fraction the amount of casein on total protein is more than the amount of casein on total protein in milk that has not been subjected to microfiltration. Preferably, the casein rich fraction comprises 1 wt % more casein on total protein than non-microfiltered milk, more preferably 2 wt %, 3 wt % or 5 wt % more casein on total protein than non-microfiltered milk and most preferably 7 wt %, 8 wt %, 9 wt % or 10 wt % more casein on total protein than non-microfiltered milk. In the serum protein rich fraction the amount of serum protein on total protein is more than the amount of serum protein on total protein in milk that has not been subjected to microfiltration. Preferably, the serum protein rich fraction comprises 10 wt %, 12 wt %, 16 wt %, or 20 wt % more serum on total protein than non-microfiltered milk, more preferably 24 wt %, 28 wt %, 30 wt %, 32 wt % or 36 wt % 40 wt % more serum on total protein than non-microfiltered milk, and most preferably 42 wt %, 46 wt %, 50 wt %, 54 wt %, 56 wt %, or 60 wt % more serum on total protein than non-microfiltered milk.

Preferably the casein rich fraction comprises more than 81 wt % casein on total protein, more preferably more than 82 wt %, 83 wt %, 84 wt % or more than 85 wt % casein on total protein, even more preferably more than 86 wt %, 87 wt %, 88 wt %, 89 wt % or more than 90 wt % of casein on total protein, and most preferably more than 91 wt %, 92 wt %, 93 wt %, 94 wt %, or more than 95 wt % of casein on total protein.

Preferably the serum protein rich fraction comprises more than 20 wt %, 22 wt %, 24 wt %, 26 wt %, or more than 28 wt % serum protein on total protein, more preferably more than 30 wt %, 32 wt %, 34 wt %, 36 wt %, or more than 38 wt % serum protein on total protein, even more preferably more than 40 wt %, 42 wt %, 44 wt %, 46 wt %, or more than 48 wt % serum protein on total protein, more preferably more than 45 wt %, 47 wt % or more than 49 wt % serum protein on total protein, more preferably more than 50 wt %, 52 wt %, 53 wt %, or more than 54 wt % serum protein on total protein, even more preferably more than 55 wt %, 56 wt %, 57 wt %, 58 wt %, or more than 59 wt % serum protein on total protein, and most preferably more than 60 wt %, 61 wt %, 62 wt %, 63 wt %, 64 wt % or more than 65 wt % serum protein on total protein.

In the method according to the invention and embodiments thereof, a pathogen removal step and microfiltration step are carried out. The pathogen removal step may be carried out before or after the microfiltration step. In a preferred embodiment of the present invention and embodiments thereof the pathogen removal step is performed before the microfiltration step.

The casein rich fraction and/or the serum protein rich fraction may be processed into a food product for infants and toddlers, medical nutrition or a food product for elderly people. It is seen that especially infants and toddlers react more allergenic to processed protein than to natural non-denatured proteins. As it is believed that non-denatured protein are more easily digested than denatured protein the food composition of the present invention is also suitable as medical nutrition and food compositions for elderly people.

In a preferred embodiment of the present invention and embodiments thereof the heating step before or after microfiltration is done at a temperature of 60° C. to 65° C., or at a temperature of 65° C. to 85° C., preferably at a temperature of 65° C. to 76° C., preferably at a temperature of 66° C. to 78° C. more preferably at a temperature of 68° C. to 74° C., even more preferably a temperature of from 67° C. to 82° C., even more preferably from 68° C. to 72° C., and most preferably at a temperature of 66-71° C. In a preferred embodiment of the present invention and embodiments thereof the heating time is from 1 to 20 minutes, more preferably from 2 to 17 minutes, more preferably from 3 to 15 minutes, more preferably from 4 to 12 minutes and even more preferably from 5 to 10 minutes, even more preferably from 1 to 300 seconds, more preferably from 2 to 270 seconds, more preferably from 3 to 240 seconds, more preferably from 4 to 210 seconds, more preferably from 5 to 180 seconds, even more preferably from 10 to 150 seconds, more preferably from 12 to 120 seconds, more preferably from 15 to 90 seconds, more preferably from 17 to 60 seconds, more preferably from 20 to 40 seconds, and most preferably from 6 to 170 seconds.

It is to be understood that a skilled person will derive the most suitable heating temperature with the most suitable heating time. In general, lower heating temperatures require longer heating times, while higher heating temperatures require less heating times.

Suitable temperature time combination may be 60° C. to 65° C. for 1 to 10 minutes or at a temperature of 65-85° C. for 5 to 200 seconds, preferably at a temperature of from 67° C. to 80° C. for 8 to 180 seconds, preferably at a temperature of 65-76° C. for 10-120 seconds, most preferably at a temperature of 66-71° C. for 5 to 180 seconds.

Suitably, the microfiltration and/or pathogen removal step is performed on milk that has been subjected to a decreaming treatment. Decreaming may be performed with any suitable method known to the skilled person. A suitable method is centrifugation, wherein the heavier protein and carbohydrates are separated from the less heavy fat particles. Preferably the milk is decreamed to a fat content that is less than about 70% of the original fat content, more preferably to less than about 50% of the original fat content, more preferably to less than about 25% of the fat content and most preferably to less than about 10% of the original fat content.

In order to make the food composition, the casein rich fraction and/or serum protein rich fraction are used. In a preferred embodiment the serum protein rich fraction is combined with the casein rich fraction or the serum protein rich fraction is combined to a milk or milk protein concentrate wherein at least 98% of the pathogens are removed and which has not been subjected to a heat treatment above 90° C., preferably not above 88° C., more preferably not above 87° C. or not above 86° C., more preferably not above 85° C., even more preferably not above 84° C., not above 83° C., not above 82° C., not above 81° C. or not above 80° C., even more preferably not above 79° C., not above 78° C., not above 77° C., not above 76° C. or not above 75° C., yet even more preferably not above 74° C., not above 73° C., not above 72° C., not above 71° C. or not above 70° C., more preferably not above 69° C. or not above 68° C. and most preferably not above 67° C., not above 66° C. or not above 65° C. or the serum protein rich fraction is combined to a milk or milk protein concentrate wherein at least 98% of the pathogens are removed and which has been subjected to a heat treatment below a temperature of 90° C., below 88° C., below 86° C., or below 85° C., more preferably below 84° C., below 83° C., below 82° C. below 81° C., or below 80° C., even more preferably below 79° C., below 78° C., below 77° C. below 76° C., or below 75° C., more preferably below 74° C., below 73° C., below 72° C. below 71° C., or below 70° C., more preferably below 69° C. or below 68° C. and most preferably below 67° C., below 66° C., or below 65° C. Preferably the serum rich fraction and/or casein rich fraction, or milk or milk protein concentrate is combined to obtain a casein:serum protein ratio of from 0.1 to 15 in the dairy based composition. For infant formulas suitably the ratio of casein:serum protein is from 0.1 to 4.0, preferably the ratio of casein:serum protein is from 0.2 to 2.5, more preferably the ratio of casein:serum protein is from 0.3 to 2.2, more preferably the ratio of casein:serum protein is from 0.5 to 2.0, more preferably the ratio of casein:serum protein is from 0.8 to 1.8, most preferably the ratio of casein:serum protein is from 1 to 1.5. Suitable ratio of casein:serum protein is from 0.4-0.7, or from 0.4 to 1.5, or from 0.6 to 1.4, or from 0.8 to 1.2. Also suitable ratio of casein:serum protein is from 1 to 2.5. For medical nutrition or nutrition for elderly a suitable ratio of casein:serum protein is from 3-15, more preferably from 4-12, more preferably from 5-11, even more preferably from 6-10, and most preferably from 7-9.

In another preferred embodiment fat is added to the composition. The fat may be any fat but is preferably a vegetable fat. Suitable fats comprise sunflower oil, soy oil, safflour oil, rape seed oil, palm oil, palm kernel oil, ricebran oil, olive oil, arachis oil, and coconut oil. Milk fat, butter oil and other animal fat such as lard are also suitable. Fish oil and algae oil are also very suitable. The fat may be a combination of different fats. Suitably the fat is a mixture of vegetable oils and butter oil. Preferably at least 25 wt % of the fat comprises butteroil, more preferably at least 40 wt % of the fat comprises butter oil.

In addition, other ingredients may be added to the food composition such as vitamins, minerals, polyunsaturated fatty acids, prebiotics, probiotics, protein, antibodies, anti-oxidants, phospholipids or nucleotides, are added to the composition. E.g. it is conventional to add to the food compositions carbohydrates, such as lactose and oligosaccharides, lipids and ingredients such as vitamins, amino acids, minerals, taurine, carnitine, nucleotides and polyamines, and antioxidants such as BHT, ascorbyl palmitate, vitamin E, α- and β-carotene, lutein, zeaxanthin, lycopene and lecithin. In addition, the food composition may be enriched with polyunsaturated fatty acids, such as gamma-linolenic acid, dihomo-gamma-linolenic acid, arachidonic acid, stearidonic acid, eicosapentaenoic acid, docosahexaenoic acid and docosapentaenoic acid. With a view to a proper development of the intestinal flora, probiotics may be added, such as lactobacilli and/or bifidobacteria, as well as prebiotics. A preferred combination of probiotics is for instance Bifidobacterium lactis with L. casei, L. paracasei, L. salivarius or L. reuteri. Examples of prebiotics include fuco-, fructo- and/or galacto-oligosaccharides, both short- and long-chain, (fuco)sialyloligosaccharides, branched (oligo) saccharides, sialic acid-rich milk products or derivatives thereof, inulin, carob bean flour, gums, which may or may not be hydrolyzed, fibers, etc.

In a preferred embodiment of the present invention and embodiments thereof the food composition is selected from the group consisting of food composition for infants or toddles, medical nutrition, of a food product for the elderly. Preferably the food composition is an infant formula. A skilled person is aware of the nutritional requirements of specialized food compositions such as for infants, toddles, weakened persons, sick persons, and/or elderly. He will know how to use the teaching of the present invention to make a food composition especially suited for e.g. infants, toddles, weakened persons, sick persons, and/or elderly.

Specifically the food product of the present invention and embodiments thereof, e.g. an infant milk formula, may contain preferably 5.0 to 12.5 energy % of protein; 40 to 55 energy % of carbohydrates; and 35 to 50 energy % of fat. The term energy %, also abbreviated as en %, represents the relative amount each constituent contributes to the total caloric value of the formula.

Protein is preferably present in the composition below 8% based on total calories of the composition. Preferably the nutritional composition comprises between 5.0 and 8.0% protein based on total calories, more preferably between 5.5 and 8.0%, and even more preferably between 5.7 and 7.6% protein based on total calories. As total calories of the composition the sum of calories delivered by the fats, proteins and digestible carbohydrates of the composition is taken. A low protein concentration ensures a lower insulin response, thereby preventing proliferation of adipocytes, especially visceral adipocytes in infants. The protein concentration in a nutritional composition is determined by the sum of protein, peptides and free amino acids. The protein concentration is determined by determining the amount of nitrogen, multiplying this with a factor 6.25. One gram of protein equals 4 kcal. Based on dry weight the composition preferably comprises less than 12 wt. % protein, more preferably between 6 to 11 wt. %, even more preferably 7 to 10 wt. %. Based on a ready-to-drink or reconstituted powder liquid product the composition preferably comprises less than 1.5 g protein per 100 ml, more preferably between 0.8 and 1.35 g per 100 ml.

The food product of the present invention and embodiments thereof, such as infant milk formula preferably comprises protein selected from the group consisting of non-human animal proteins (such as milk proteins, meat proteins and egg proteins), vegetable proteins (such as soy protein, wheat protein, rice protein, and pea protein) and amino acids and mixtures thereof. Preferably the food product of the present invention and embodiments thereof comprise cow milk derived nitrogen source, particularly cow milk proteins such as casein and whey proteins. In one embodiment the food product of the present invention and embodiments thereof such as infant milk formula comprises hydrolyzed milk protein, for example hydrolyzed casein and/or hydrolyzed whey protein.

Because lactose is a most important digestible carbohydrate source for infants, the food product of the present invention and embodiments thereof such as infant milk formula preferably comprises at least 35 wt. % lactose based on weight of total digestible carbohydrate, more preferably at least 50 wt. %, most preferably at least 75 wt. %.

The food product of the present invention and embodiments thereof, such as infant milk formula, preferably has a caloric density between 0.1 and 2.5 kcal/ml, even more preferably a caloric density of between 0.5 and 1.5 kcal/ml, most preferably between 0.6 and 0.8 kcal/ml. The food product of the present invention and embodiments thereof such as infant milk formula preferably has an osmolality between 50 and 500 mOsm/kg, more preferably between 100 and 400 mOsm/kg.

When in liquid form, the food product of the present invention and embodiments thereof such as infant milk formula preferably has a viscosity between 1 and 100 mPa·s, preferably between 1 and 60 mPa·s, more preferably between 1 and 20 mPa·s, most preferably between 1 and 10 mPa·s. The viscosity of the present liquid food compositions can be suitably determined using a Physica Rheometer MCR 300 (Physica Messtechnik GmbH, Ostfilden, Germany) at shear rate of 95 s<−1> at 20° C.

In one embodiment of the food product of the present invention and/or embodiments thereof, such as infant milk formula, the food product is in powder form. In one embodiment the present invention concerns packaged powder infant milk formula, preferably accompanied with instructions to admix the powder with a suitable amount of liquid, preferably with water, thereby resulting in a liquid food composition, preferably infant nutrition, with a viscosity between 1 and 100 mPa·s. This viscosity closely resembles the viscosity of human milk. Furthermore, a low viscosity results in a normal gastric emptying and a better energy intake, which is essential for infants, toddlers, sick and elderly, which need the energy for optimal growth, development and/or recovery.

Normally infants are fed between 80 and 250 ml of infant milk formula per kg body weight per day, more preferably between 120 and 220 ml of infant milk formula per kg body weight per day, more preferably between 150 ml and 180 ml of an infant milk formula per kg body weight per day.

It should be understood that it may be necessary to concentrate the food product. If such a concentration method is employed it is desirable to use a mild concentration method such that less than 25 wt % of the protein is denatured in the concentrated product. Suitable concentration methods are forward osmosis, reverse osmosis, membrane distillation, freeze concentration, thin-film spinning cone evaporator, and scraped film evaporators. Concentration techniques may be optimised by reduced residence time distribution, and/or improved heat transfer to minimise denaturation.

Dry products have the advantage that they have a longer shelf life due to the reduced level or even lack of water. In addition, dry products are less heavy, and have a smaller volume so that transportation is easier. However, conventional drying techniques will denature a considerable amount of the proteins present. Therefore, the drying is preferably a mild drying step, such that less than 25 wt % of the protein is denatured in the dried product. Suitable drying steps are spray drying, drying in the presence of surface active components, gas injection, drying with super critical CO₂, freeze drying.

Suitably the milk and products obtained from the milk are during the process not subjected to a heat treatment at a temperature above 90° C., preferably not above 88° C., more preferably not above 87° C. or not above 86° C., more preferably not above 85° C., even more preferably not above 84° C., not above 83° C., not above 82° C., not above 81° C. or not above 80° C., even more preferably not above 79° C., not above 78° C., not above 77° C., not above 76° C. or not above 75° C., yet even more preferably not above 74° C., not above 73° C., not above 72° C., not above 71° C. or not above 70° C., more preferably not above 69° C. or not above 68° C. and most preferably not above 67° C., not above 66° C. or not above 65° C., also more preferably not above 64° C., 63° C., 62° C., 61° C., or 60° C., more preferably not above 59° C., 58° C., 57° C., 56° C., or 55° C., most preferably not above 54° C., 53° C., 52° C., 51° C., or 50° C. In a preferred embodiment the milk and products obtained from the milk are during the process subjected to a heat treatment wherein the heat treatment is performed at a temperature below 90° C., below 88° C., below 86° C., or below 85° C., more preferably below 84° C., below 83° C., below 82° C. below 81° C., or below 80° C., even more preferably below 79° C., below 78° C., below 77° C. below 76° C., or below 75° C., more preferably below 74° C., below 73° C., below 72° C. below 71° C., or below 70° C., more preferably below 69° C. or below 68° C. and most preferably below 67° C., below 66° C., or below 65° C., also more preferably below 64° C., 63° C., 62° C., 61° C., or 60° C., more preferably below 59° C., 58° C., 57° C., 56° C., or 55° C., most preferably below 54° C., 53° C., 52° C., 51° C., or 50° C.

In a preferred embodiment, a method according to the invention comprises the steps

(a) Treating the milk such that at least 98% of the pathogens is removed

(b) Treating the milk with a microfilter of a poresize of 0.01-2 micron such that at least a casein rich fraction and a serum protein rich fraction is obtained

(c) Subjecting the milk to a heating treatment before or after the treatment of the milk with the microfilter

(d) Combining the serum protein rich fraction with the casein rich fraction or with a milk wherein at least 98% of the pathogens are removed and which has not been subjected to a heat treatment above temperature 75° C. or with a milk protein concentrate wherein at least 98% of the pathogens are removed and which has not been subjected to a heat treatment above temperature 75° C., to obtain a casein:serum protein ratio of 0.1-15.0 in the dairy based composition

(e) Optionally adding a fat to the composition

(f) Optionally adding additional ingredients selected from the group consisting of vitamins, minerals, polyunsaturated fatty acids, prebiotics, probiotics, protein, antibodies, nucleotides, antioxidants, and phospholipids to the composition.

(g) Concentrating the compositions such that less than 25 wt % of the protein is denatured in the concentrated composition

(h) Drying the composition such that less than 25 wt % of the protein is denatured in the dried composition, wherein during the process the milk and the products obtained from the milk are not subjected to a heat treatment at a temperature above 90° C.

In a preferred embodiment of the invention the food product is selected from the group consisting of a food product for infants or toddlers, medical nutrition or a food product for elderly people.

The present invention is also directed to dairy based food composition obtainable by a method according the invention and/or embodiments thereof. More preferably the present invention is also directed to an infant formula composition obtainable by a method according the invention and or embodiments thereof.

The method according to the invention yields a casein rich fraction and a serum protein rich fraction. Preferably the casein rich fraction comprises more than 81 wt % casein on total protein and less than 25 wt % of the protein is denatured. Also preferred is a serum protein rich fraction comprising more than 20 wt % serum protein on total protein, and less than 25 wt % of the protein is denatured. It is to be understood that the term “denatured” relates only to denaturable proteins, that is only to serum proteins. That is “less than 25 wt. % of the protein is denatured” means that less than 25 wt. % of the total of serum proteins is denatured.

In a preferred embodiment, the casein rich fractions comprises more than 85 wt % casein on total protein, even more preferably more than 90 wt % of casein on total protein, and most preferably more than 95 wt % of casein on total protein, and less than 25 wt % of the protein is denatured.

Also preferred is a serum protein rich fraction comprising more than 20 wt % serum protein on total protein, and less than 25 wt % of the protein is denatured.

In another preferred embodiment the serum protein rich fractions comprises more than 30 wt % serum protein on total protein, more preferably more than 40 wt % serum protein on total protein, more preferably more than 45 wt % serum protein on total protein, more preferably more than 50 wt % serum protein on total protein, even more preferably more than 55 wt % serum protein on total protein, and most preferably more than 60 wt % serum protein on total protein, and less than 25 wt % of the protein is denatured.

In another aspect, the present invention and/or embodiments thereof are directed to a dairy based food composition wherein less than 25 wt % of the protein is denatured and the ratio of casein:serum protein is 0.1-15. Suitably less than 22 wt % of the protein is denatured, more suitably less than 20 wt % of the protein is denatured, more preferably less than 17 wt % of the protein is denatured, more preferably less than 14 wt % of the protein is denatured and most preferably less than 11 wt % of the protein is denatured. As is explained earlier, denaturation comprises unfolding, aggregation, glycation and any other process that makes the protein loose its biological function. In preferred embodiment, less than 20 wt % of the protein is glycated, more preferably less than 17 wt % of the protein is glycated, more preferably less than 15 wt % of the protein is glycated, more preferably less than 13 wt % of the protein is glycated and most preferably less than 10 wt % of the protein is glycated.

In another aspect, the present invention and/or embodiments thereof are directed to a dairy based food composition which has a furosine content lower than 0.7 g/100 g protein, preferably lower than 0.5 g/100 g protein, more preferably lower than 0.3 g/100 g protein and most preferably lower than 0.2 g/100 g protein.

In yet another aspect, the present invention and/or embodiments thereof are directed to a dairy based food composition which has a Fast index lower than 20, preferably lower than 16 and most preferably lower than 13. Fast index is measured according to Birlouez-Aragon, I., Sabat, P., & Gouti, N. (2002). A new method for discriminating milk heat treatment. International Dairy Journal, 12, 59-67. Measurements on an Agilent Cary Eclipse fluorescence spectrophotometer; Fluorescence_{tryp} at 290/340 nm and 600 V on multiplier, Fluorescence_{AMP} at 330/420 and 700 V on the multiplier.

In yet a further aspect, the present invention and/or embodiments thereof are directed to a dairy based food composition wherein less than 25% of the alpha-Lactalbumin is denatured, preferably less than 20%, more preferably less than 15%, yet more preferably less than 10% and most preferred less than 5%. Preferably, the dairy based food composition according to the present invention and/or embodiments thereof is an infant formula.

Preferably the composition according to the present invention and/or embodiments thereof comprises 0.5 to 40 wt % protein for a ready to use product, and 5 to 80 wt % protein in a dry product, more preferably 1 to 30 wt % of protein for a ready use product, or 10 to 60 wt % of a dry product, most preferably 1.5 to 25 wt % protein for a ready to use product, or 20 to 50 wt % for a dry product.

In a preferred embodiment of the invention the food product is selected from the group consisting of a food product for infants or toddlers, medical nutrition or a food product for elderly people.

Suitably the ratio of casein:serum protein is from 0.1 to 15. For infant formulas suitably the ratio of casein:serum protein is from 0.1 to 4.0, preferably the ratio of casein:serum protein is from 0.2 to 2.5, more preferably the ratio of casein:serum protein is from 0.3 to 2.2, more preferably the ratio of casein:serum protein is from 0.5 to 2.0, more preferably the ratio of casein:serum protein is from 0.8 to 1.8, most preferably the ratio of casein:serum protein is from 1 to 1.5. Suitable ratio of casein:serum protein is from 0.4-0.7, or from 0.4 to 1.5, or from 0.6 to 1.4, or from 0.8 to 1.2. Also suitable ratio of casein:serum protein is from 1 to 2.5. For medical nutrition or nutrition for elderly a suitable ratio of casein:serum protein is from 3-15, more preferably from 4-12, more preferably from 5-11, even more preferably from 6-10, and most preferably from 7-9.

The dairy based food composition may also comprise fat in an amount of between 0.5 and 15 wt % fat for a ready to use product and 2 to 40 wt % fat in a dry product, more preferably between 1 and 8 wt % fat for a ready to use product or 3 to 30 wt % in a dry product, most preferably 2 to 5 wt % fat in a ready to use product or 5 to 20 wt % in a dry product. The fat may be any fat but is preferably a vegetable fat. Suitable fats comprise sunflower oil, soy oil, safflour oil, rape seed oil, palm oil, palm kernel oil, ricebran oil, olive oil, arachis oil, and coconut oil. Milk fat, butter oil and other animal fat such as lard are also suitable. Fish oil and algae oil are also very suitable. The fat may be a combination of different fats. Suitably the fat is a mixture of vegetable oils and butter oil. Preferably at least 25 wt % of the fat comprises butteroil, more preferably at least 40 wt % of the fat comprises butter oil.

In a preferred embodiment the composition according to the invention comprises an amount of beta-casein of from 2 to 4.5 g/L of a ready to use product, preferably from 2.5 to 4 g/L ready to use product and most preferably from 3 to 3.5 g/L ready to use product. Suitably a dry product contains 10-50 mg beta-casein, more suitably 15-40 mg beta casein and most preferably from 20-30 mg beta casein per gram dry product.

In another preferred embodiment the composition according to the invention comprises an amount of alpha lactalbumin from 2 to 4.5 g/L of a ready to use product, preferably from 2.5 to 4 g/L ready to use product and most preferably from 3 to 3.5 g/L ready to use product. Suitably a dry product contains 10-50 mg alpha lactalbumin, more suitably 15-40 mg alpha lactalbumin and most preferably from 20-30 mg alpha lactalbumin per gram dry product.

In another preferred embodiment, the composition according to the invention comprises less than 2 g/L alpha casein in a ready to use product, more preferably less than 1 g/L, even more preferably less than 100 mg/L and most preferably less than 10 mg/L in a ready to use product. Even less than 1 mg/L alpha casein in a ready to use product is very suitable. In a dry product, preferably less than 15 mg alpha casein per gram dry product is present, more preferably less than 1 mg alpha casein per gram dry product is present, more preferably less than 500 ng/g and most preferably less than 100 ng/g alpha casein in a dry product.

In another preferred embodiment, the composition according to the invention comprises less than 2 g/L beta lactoglogulin in a ready to use product, more preferably less than 1 g/L, even more preferably less than 100 mg/L and most preferably less than 10 mg/L in a ready to use product. Even less than 1 mg/L beta lactoglogulin in a ready to use product is very suitable. In a dry product, preferably less than 15 mg beta lactoglogulin per gram dry product is present, more preferably less than 1 mg beta lactoglogulin per gram dry product is present, more preferably less than 500 ng/g and most preferably less than 100 ng/g beta lactoglogulin in a dry product.

In a preferred embodiment, the composition according to the invention has a furosine content lower than 0.7 g/100 g protein, preferably lower than 0.5 g/100 g protein, more preferably lower than 0.3 g/100 g protein and most preferably lower than 0.2 g/100 g protein. In another preferred embodiment, the composition according to the invention has a Fast index lower than 20, preferably lower than 16 and most preferably lower than 13. In yet another preferred embodiment, in the composition according to the invention less than 25% of the total amount of alpha-Lactalbumin, β-lactoglobulin and bovine serum albumin is denatured, preferably less than 20%, more preferably less than 15%, yet more preferably less than 10% and most preferred less than 5%. In yet another preferred embodiment, in the composition according to the invention less than 25% of the alpha-Lactalbumin is denatured, preferably less than 20%, more preferably less than 15%, yet more preferably less than 10% and most preferred less than 5%.

Preferably, the dairy based food composition according to the present invention and/or embodiments thereof is an infant or toddler formula.

Infant (baby) formula is generally for use, in addition to or in lieu of human breast milk, with infants up to 18 months old. Toddler formula generally refers to follow-on formula for children of 18-48 months. Obviously, it is not excluded in accordance with the invention to use the milk proteins and milk protein compositions obtained, also for other purposes such as enteral food, medical nutrition for children and for the elderly.

It will be understood that any nutritional compositions, such as infant or toddler formula, provided in accordance with the invention, may comprise any further conventional ingredients. E.g. it is conventional to add to baby and infant food and therapeutic compositions carbohydrates, such as lactose and oligosaccharides, lipids and ingredients such as vitamins, amino acids, minerals, taurine, carnitine, nucleotides and polyamines, and antioxidants such as BHT, ascorbyl palmitate, vitamin E, α- and β-carotene, lutein, zeaxanthin, lycopene and lecithin. The lipids are mostly of vegetable origin. In addition, the food or the therapeutic composition may be enriched with polyunsaturated fatty acids, such as gamma-linolenic acid, dihomo-gamma-linolenic acid, arachidonic acid, stearidonic acid, eicosapentaenoic acid, docosahexaenoic acid and docosapentaenoic acid. With a view to a proper development of the intestinal flora, probiotics may be added, such as lactobacilli and/or bifidobacteria, as well as prebiotics. A preferred combination of probiotics is for instance Bifidobacterium lactis with L. casei, L. paracasei, L. salivarius or L. reuteri. Examples of prebiotics include fuco-, fructo- and/or galacto-oligosaccharides, both short- and long-chain, (fuco)sialyloligosaccharides, branched (oligo) saccharides, sialic acid-rich milk products or derivatives thereof, inulin, carob bean flour, gums, which may or may not be hydrolyzed, fibers, protein hydrolysates, nucleotides, etc.

The invention will now be illustrated in the following, non-limiting example.

### Example

Infant formula was manufactured in three steps.

1. Bacterial Reduction of Milk

Raw bovine milk was decreamed by centrifugation. The skimmed milk was subsequently microfiltered at a temperature of 50° C. by making use of a continuous membrane system equipped with ceramic membranes (Membralox) with a pore size of 1.4 μm. Afterwards, the permeate was heat treated with a plate heat exchanger for 20 seconds at a temperature of 72° C. in order to inactivate lipase.

The bacterial counts in skimmed milk before and after microfiltration are presented in Table 1.

TABLE 1

| | Before | After |
|---|---|---|
| Total plate count [cfu/ml] | 10,000-50,000 | 10-100 |
| Mesophilic spores [cfu/10 ml] | 500-1000 | 1-10 |

2. Preparation of a Casein-Rich and Serum-Protein Rich Concentrate

Bactofiltered milk from example 1 was processed (VCR=5) with spiral wounded 0.3 μm membranes (DSS) at 15° C. to separate the milk into a serum-protein rich permeate and a casein-protein rich retentate. The MF-concentrate consisted of 80.4% on dry matter. The protein composition of this fraction was 90% casein and 10% serum protein.

The MF-permeate was subsequently concentrated with reversed osmosis and ultrafiltrated (VCR=15) with a spiral wounded 10 kDa membrane (Koch) to obtain a serum protein concentrate with 30% dry matter. The milk serum protein concentrate powder consisted of 60.4% protein on dry matter, 17.1% casein protein and 43.3% serum protein. The casein fraction of this product contained 30% αₛ-casein, 66% β- and γ-casein and 4% κ-casein, whereas the serum protein fraction contained 21% α-lactalbumin and 73% β-lactoglobulin. The amino acid pattern of the milk serum protein concentrate is presented in Table 2.

TABLE 2

| | Concentration |
|---|---|
| | [g/100 g crude |
| Amino acid | protein] |
| Cysteine | 2.6 |
| Histidine | 2.2 |
| Isoleucine | 5.6 |
| Leucine | 12.7 |
| Lysine | 10.0 |
| Methionine | 2.4 |
| Phenylalanine | 4.2 |
| Threonine | 5.2 |
| Tryptophan | 2.3 |
| Tyrosine | 3.7 |
| Valine | 5.7 |
| Glycine | 1.9 |
| Alanine | 4.8 |
| Proline | 5.9 |
| Serine | 4.8 |
| Arginine | 2.8 |
| Aspargic acid | 11.3 |
| Glutamic acid | 18.6 |

3. Preparation of an IF Base Comprising the Serum-Protein Rich Concentrate

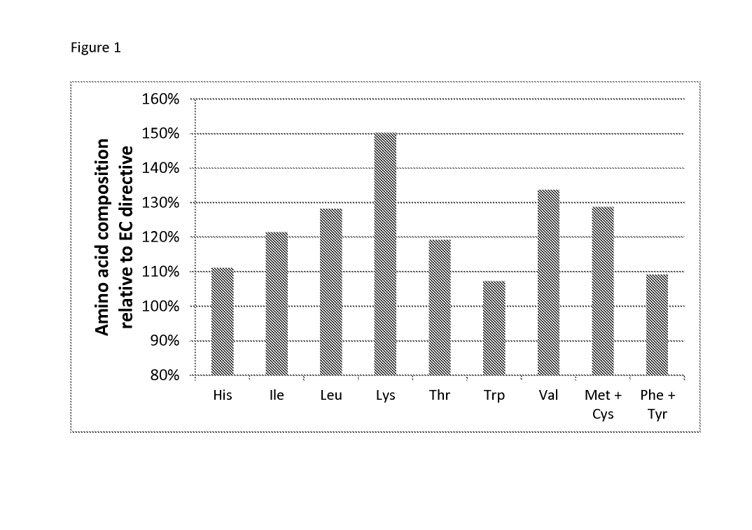

2.1 kg of lactose was dissolved in water of 50° C. and this was added to 7.8 kg of bactofiltrated milk (see 1) and 1.5 kg of milk serum protein concentrate (see 2). This mixture was heated during 20 s at 72° C. and afterwards 1.7 kg of vegetable oil (55° C.) was added while stirring. After cooling to 25° C. followed by mineral addition, the final mixture was pasteurized (13 s at 72° C.), homogenized (150/50 bar) and spray dried (Tinlet=160° C., Toutlet=85° C.). The product temperature in spray drying was not higher than the outlet air temperature. Afterwards, 0.7 kg lactose was dry blended with the powder to obtain an IF-base in which 7.3% of the energy comes from proteins, 49.2% from fat and 43.5% from carbohydrates. The IF base consisted of 0.98 g casein/100 kcal, 0.80 g serum protein/100 kcal and 0.07 g NPN/100 kcal. In FIG. 1, the composition of essential amino acids relative to the minimal required essential amino acids as defined in the COMMISSION DIRECTIVE 2006/141/EC, ANNEX V is shown.

This mildly heat-treated IF base powder contained more native serum proteins and contained less furosine and had a lower Fast index, which both are measures for protein glycation, than Infant Formula available in the market.

TABLE 3

| | Native α- | Native β- | | | | |
|---|---|---|---|---|---|---|
| | lactal- | lacto- | Native | CMP | | |
| | bumin | globulin | BSA | [mg/g | Furosine | |
| | [mg/g | [mg/g | [mg/g | pro- | [g/100 g | Fast |
| | protein] | protein] | protein] | tein] | protein] | index* |
| IF base - | 90 | 252 | 9 | 0 | 0.1 | 12 |
| invention | (<5%) | (±15%) | (±25%) | | | |
| (content | | | | | | |
| and % | | | | | | |
| denatu- | | | | | | |
| ration) | | | | | | |
| IF - ref A | 11 | 9 | 1 | 56 | 0.8 | 22 |
| IF - ref B | 46 | 125 | 2 | 87 | 1.0 | Nd |
| IF - ref C | 32 | 120 | 0 | 31 | 0.9 | Nd |

*Fast index according to: Birlouez-Aragon, I., Sabat, P., & Gouti, N.

(2002). A new method for discriminating milk heat treatment. International Dairy Journal, 12, 59-67. Measurements on an Agilent Cary Eclipse fluorescence spectrophotometer; Fluorescence_{tryp} at 290/340 nm and 600 V on multiplier, Fluorescence_{AMP} at 330/420 and 700 V on the multiplier.

1. Method to produce a dairy based food composition comprising milk protein comprising the steps
(a) Treating the milk such that at least 98% of the pathogens is removed
(b) Treating the milk with a microfilter of a poresize of 0.01-2 micron such that at least a casein rich fraction and a serum protein rich fraction is obtained,
wherein the milk is subjected to a heating treatment before or after the microfiltration and wherein during the production of the food composition the milk and products obtained from the milk are not subjected to a heat treatment at a temperature above 90° C., and wherein the serum protein rich fraction and/or the casein rich fraction is processed into a food composition.

2. Method according to claim 1 wherein the treatment to remove at least 98% of the pathogens is selected from the group consisting of
bacterial filtration with a poresize of 0.5-2.5 micron, preferably at a temperature of from 25 to 65° C.;
centrifugation;
use of antibody to remove pathogens.

3. Method according to claim 1 wherein the microfiltration step is performed at a temperature of from 0 to 25° C.

4. Method according to claim 1 wherein the milk is heated at a temperature of 60-65° C. for 1-10 minutes or at a temperature of 65-85° C. for 5-180 seconds, preferably at a temperature of 65-76° C. for 10-120 seconds, most preferably at a temperature of 66-71° C. for 5 to 180 seconds.

5. Method according to claim 1 wherein the pore size of the microfiltration is between 0.05 and 1.2 μm.

6. Method according to claim 1 wherein the milk is subjected to a decreaming treatment before the microfiltration step, preferably before the pathogen removal step.

7. Method according to claim 1 wherein the serum protein rich fraction is combined with the casein rich fraction or combined to a milk wherein at least 98% of the pathogens are removed and which has not been subjected to a heat treatment above temperature 75° C. or combined to a milk protein concentrate wherein at least 98% of the pathogens are removed and which has not been subjected to a heat treatment above temperature 75° C., to obtain a casein:serum protein ratio of from 0.1 to 15 in the dairy based composition, preferably from 0.1-4 or from 3-15.

8. Method according to claim 1 wherein a fat is added to the composition.

9. Method according to claim 8 wherein at least 25 wt % of the fat comprises butteroil.

10. Method according to claim 1 wherein ingredients selected from the group consisting of vitamins, minerals, polyunsaturated fatty acids, prebiotics, probiotics, protein, antibodies, nucleotides, antioxidants and phopholipids are added to the composition.

11. Method according to claim 1 wherein a concentration step is present wherein the concentration is such that less than 25 wt % of the protein is denatured in the concentrated product.

12. Method according to claim 1 wherein the concentration step is selected from the group consisting of forward osmosis, reverse osmosis, membrane distillation, freeze concentration, thin-film spinning cone evaporator, and scraped film evaporators.

13. Method according to claim 1 wherein a drying step is present, wherein the drying is such that less than 25 wt % of the protein is denatured in the dried product.

14. Method according to claim 1 wherein the drying step is selected from the group consisting of spray drying, drying in the presence of surface active components, drying with gas injection, drying with super critical CO₂, freeze drying.

15. Method according to claim 1 wherein during the process the milk is not subjected to a heat treatment at a temperature above 75° C.

16. Method according to claim 1 wherein the dairy based food composition is a dry composition, comprising the steps
(a) Treating the milk such that at least 98% of the pathogens is removed
(b) Treating the milk with a microfilter of a poresize of 0.01-2 micron such that at least a casein rich fraction and a serum protein rich fraction is obtained
(c) Subjecting the milk to a heating treatment before or after the treatment of the milk with microfilter
(d) Combining the serum protein rich fraction with the casein rich fraction or with a milk wherein at least 98% of the pathogens are removed and which has not been subjected to a heat treatment above temperature 75° C. or with a milk protein concentrate wherein at least 98% of the pathogens are removed and which has not been subjected to a heat treatment above temperature 75° C., to obtain a casein:serum protein ratio of 0.1-15 in the dairy based composition
(e) Optionally adding a fat to the composition
(f) Optionally adding additional ingredients selected from the group consisting of vitamins, minerals, polyunsaturated fatty acids, prebiotics, probiotics, protein, antibodies, nucleotides, antioxidants and phospholipids to the composition.
(g) Concentrating the compositions such that less than 25 wt % of the protein is denatured in the concentrated composition
(h) Drying the composition such that less than 25 wt % of the protein is denatured in the dried composition, wherein during the process the milk and the products obtained from the milk are not subjected to a heat treatment at a temperature above 90° C.

17. Method according to claim 1 wherein the dairy based food composition is a infant formula composition comprising preferably 5.0 to 12.5 energy % of protein; 40 to 55 energy % of carbohydrates; and 35 to 50 energy % of fat.

18. Dairy based food composition obtainable by a method according to claim 1.

19. Dairy based composition wherein the composition is a casein rich fraction wherein more than 80 wt % of the protein is casein and less than 25 wt % of the protein is denatured.

20. Dairy based composition wherein the composition is a serum protein rich fraction wherein more than 20 wt % of the protein is serum protein and less than 25 wt % of the protein is denatured.

21. Dairy based food composition wherein less than 25 wt % of the protein is denatured and the ratio of casein:serum protein is 0.1-15.

22. Dairy based food composition with a furosine content lower than 0.7 g/100 g protein, preferably lower than 0.5 g/100 g protein, more preferably lower than 0.3 g/100 g protein and most preferably lower than 0.2/100 g protein.

23. Dairy based composition with a Fast index lower than 20, preferably lower than 16 and most preferably lower than 13.

24. Dairy based composition in which less than 25% of the total amount of alpha-Lactalbumin, beta-lactoglobulin and bovine serum albumin is denatured, preferably less than 20%, more preferably less than 15%.

25. Composition according to claim 18 wherein the food product is selected from the group consisting of a food product for infants or toddlers, medical nutrition or a food product for elderly people.

26. Composition according to claim 18 comprising 0.5 to 40 wt % protein for a ready to use product, and 5 to 80 wt % protein in a dry product.

27. Composition according to claim 18 wherein ratio of casein:serum protein is from 0.1 to 4.0, preferably 0.2-2.5, more preferably 0.4-1.5, most preferably 0.8-1.2.

28. Composition according to claim 18 wherein ratio of casein:serum protein is from 3-15, more preferably from 4-12, more preferably from 5-11, even more preferably from 6-10, and most preferably from 7-9.

29. Composition according to claim 18 wherein the amount of fat is between 0.5 and 15 wt % for a ready to use product and 2 to 40 wt % in a dry product.

30. Composition according to claim 18 wherein the fat comprises at least 25 wt % of butteroil.

31. Composition according to claim 18 wherein the composition is an infant or toddler formula.

32. Composition according to claim 31 wherein the infant formula comprises 5.0 to 12.5 energy % of protein; 40 to 55 energy % of carbohydrates; and 35 to 50 energy % of fat.

33. Composition according to claim 21 wherein the food product is selected from the group consisting of a food product for infants or toddlers, medical nutrition or a food product for elderly people.

34. Composition according to claim 25 comprising 0.5 to 40 wt % protein for a ready to use product, and 5 to 80 wt % protein in a dry product.

35. Composition according to claim 21 wherein ratio of casein:serum protein is from 0.1 to 4.0, preferably 0.2-2.5, more preferably 0.4-1.5, most preferably 0.8-1.2.

36. Composition according to claim 21 wherein ratio of casein:serum protein is from 3-15, more preferably from 4-12, more preferably from 5-11, even more preferably from 6-10, and most preferably from 7-9.
